(19) United States
(12) Patent Application Publication
(10) Pub. No.: US 2025/0390563 A1
(43) Pub. Date: Dec. 25, 2025

(54) DEVICE SECURITY VIA HARDWARE CHANNEL LOCK

(71) Applicant: MOTOROLA MOBILITY LLC, WILMINGTON, DE (US)

(72) Inventors: RANJEET GUPTA, Aurora, IL (US); Ajit Kumar Panda, Vernon Hills, IL (US); Debora Renno Diamantino, São Paulo (BR)

(21) Appl. No.: 18/754,089

(22) Filed: Jun. 25, 2024

(51) Int. Cl. G06F 21/31; G06F 21/70

(52) U.S. Cl. CPC G06F 21/31; G06F 21/70

(57) ABSTRACT

A method includes detecting, by a processor of an electronic device, a transitioning of the electronic device into a second locked state that provides enhanced security by preventing background application access to at least one hardware component of the electronic device that has a corresponding hardware channel used by the background application to access the hardware component. The method includes, in response to detecting transitioning of the electronic device into the second locked state, de-activating a hardware channel associated each of with the at least one hardware component, the deactivation of the hardware channel preventing access by the one or more background applications to access the at least one hardware component including preventing receipt of inputs from at least one input device while the electronic device is in the second locked state.

### BACKGROUND

### 1. Technical Field

The present disclosure generally relates to electronic devices, and more specifically to electronic devices that enable background applications to access hardware devices in the background.

### 2. Description of the Related Art

Many modern electronic devices, such as smart phones, voice assistant devices, and other types of “smart” electronic devices, provide a feature that allows installed applications to operate and access hardware components in the background. For example, smart phones are equipped with an artificial intelligence (AI) component installed thereon to provide voice assistance services. These AI components are designed to be available on-demand and thus operate in an always-on mode such that the AI component continually monitors and records surrounding sounds for potential trigger words in detected human voices. To perform their stated functions, these applications record the user's words in the background without the user even being aware of the recording.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the electronic device to implement a secure lock feature that prevents background applications from accessing hardware devices while the electronic device is in the screen locked state, according to one or more embodiments;

FIGS. 2A-2C provide examples of a settings user interface presenting an example listing of device hardware components with corresponding firmware components having respective paths that can be modified to prevent access to the corresponding hardware device to support a fully locked/secured state of the electronic device, according to one or more embodiments;

FIG. 3 depicts an example settings user interface for configuring the electronic device to operate in a second lock state that prevents access to hardware devices by background applications, according to one or more embodiments;

FIG. 4 depicts another example settings user interface for configuring the electronic device to operate in the second lock state, with granular selection of hardware devices to restrict access to, according to one or more embodiments;

FIG. 5 depicts an example settings user interface enabling the granular selection of hardware devices to restrict access to during the second lock state, according to one or more embodiments;

FIG. 6 depicts the electronic device with a modified first lock screen with selectable options for transitioning the device to the second locked state, according to one or more embodiments;

FIG. 7 depicts the electronic device of FIG. 6 transitioned to the second locked state and presenting a second lock screen with indications that access to the hardware devices are locked, according to one or more embodiments;

FIG. 8 illustrates an example environment in which an electronic device is placed in the second locked state by a remote trigger provided by a connected second device, according to one or more embodiments;

FIG. 9 illustrates a flowchart of a computer-implemented method for enabling an electronic device to be placed into a second lock state, according to one or more embodiments;

FIG. 10 illustrates a flowchart of a second computer-implemented method for responding to an exception trigger/condition received/detected while the electronic device is in the second locked state, according to one or more embodiments; and

FIG. 11 illustrates a flowchart of a third computer-implemented method for activating the second lock state based on user selection, according to one or more embodiments.

### DETAILED DESCRIPTION

According to aspects of the present disclosure, an electronic device, a method, and a computer program product provide techniques for preventing access to hardware components of the electronic device by background applications while the electronic device is in the locked screen state. According to one aspect, the method includes detecting, by a processor of an electronic device, a transitioning of the electronic device into a second locked state, which provides enhanced security by preventing background application access to at least one hardware component of the electronic device. The method includes in response to detecting transitioning of the electronic device into the second locked state, de-activating a hardware channel associated with each of the at least one hardware component, the deactivation of the hardware channel preventing access by the one or more background applications to the respective hardware component while the electronic device is in the second locked state.

An electronic user device often ships with certain applications pre-installed thereon. Additionally, a user of the electronic device will typically install many different applications on the electronic device and provide consent to the installed application(s) to use various permissions, including access to hardware components of the electronic device, such as the camera, microphone, storage, WiFi and/or Bluetooth adapters, etc. Certain pre-installed and user-installed applications operate in the background and continue to operate and access the hardware components (i.e., via a hardware channel) even when the electronic device is placed in a locked screen state (i.e., a display screen state in which access to certain operational features and applications are prevented unless/until the user enters a login credential or otherwise provides a required authentication to unlock the device). Over time, a device user loses track of which applications can access the device hardware in the background. As a result, these applications, including artificial intelligence (AI) based applications such as user assistance applications, continue to be able to monitor the device environment and capture or record events occurring with and around the device. The hardware channel becomes vulnerable, as the installed application has permission to access and can use the hardware channels anytime and anywhere since the user has provided consent during installation or the device was shipped with the application having hardware access pre-set, as a default setting. Such access to the hardware channels presents a security threat to the device and the user.

The electronic devices often include a settings option by which a user can manually modify and individually disable/turn off the background access permissions for each of the various applications. However, most regular users are unfamiliar with this settings feature being available on their device or how to access that feature. For those with such knowledge, however, the process of manually turning off each such access permission is tedious and time consuming. Further, the feature is often welcomed and appropriate for when the user wishes to quickly access a particular hardware component. If the user has disabled the access and later requires the access be re-activated, the user has to resort to accessing the settings windows and toggling the access back on for each individual application requiring access and/or for each hardware component. Additionally, however, the user may not be aware the hardware access is blocked based on the setting, and the user is thus prevented from accessing the associated hardware feature while using the electronic device.

Accordingly, aspects of the disclosure provide a solution to both (i) eliminate the security risks with these background applications operating and accessing the hardware channels while the device is in a locked state and (ii) remove the requirement for performing a tedious process of manually deactivating (and/or re-activating) the background access to the hardware channels for specific applications. According to one or more embodiments, a new secure lock state is provided for enabling and disabling the hardware channels for device hardware components based on the locked state of the electronic device state and the device usage. According to one or more embodiments, when the electronic device is screen locked (i.e., requiring a user credential to be unlocked to provide access to the device and applications thereon), aspects of the disclosure disables the hardware channels for these hardware devices at the hardware/firmware level, which then prevents the background application from performing un-intended tasks or malicious operations in the background while the device is locked.

The disclosed embodiments alleviate the aforementioned issues by introducing a method and device lock state to secure the access to the device's hardware channels when the electronic device is in the locked state. Thus, the device security is enhanced by disallowing the access that would otherwise allow background capture of user information/data without the user's knowledge. A new secure lock state (or second lock state) is provided, and one or more methods are provided to trigger the device's entry into the secure/second lock state. With this second lock state, all applications and services, including AI and non-AI applications and services, which normally has access to the device hardware components, e.g., the microphone, camera, SD device, SIM card, WiFI/BT/NFC adapters, etc., in the normal device lock state (a first lock screen state) are blocked from accessing these hardware components by disabling the channels when the device is secure locked. According to one aspect, disabling the hardware channels includes disabling the firmware, thus making the firmware and by extension the hardware component inoperable. According to various different embodiments, disabling the firmware can be accomplished by toggling the firmware activation option on/off or removing a block of code for an access path to the firmware, etc. The second lock state effectively overwrites or removes the background application's hardware access privileges.

According to one or more aspects, entry into the second locked state can be system or user controlled, and the electronic device transitions back to its normal operating state in which the hardware access restriction is removed/revoked when the device is subsequently unlocked (by entry of a user authentication credential), thus providing a seamless user experience. Thus, the embodiments provide the benefits of enhancing user privacy and device security without completely disabling the access to hardware components when the device is returned to the unlocked state. Additional benefits include enabling an override of certain ones of the hardware channel locks for certain pre-defined exempted services/operations, such as incoming calls, SOS and other emergency calls, and text messages. The override applies only to the hardware channels used by the exempt services and only during the time that the exempt services are operating on the electronic device. In one or more embodiments, an intermediate lock state is defined to provide/support this feature.

Accordingly, one or more embodiments provide an electronic device that includes: at least one hardware component each having a corresponding hardware channel for access to a respective one of the at least one hardware component by one or more applications and an operating system, the at least one hardware component includes at least one input device; a memory having stored thereon the one or more applications and the operating system that are configured to access the at least one hardware component, including while the electronic device is in a first screen locked state (“first locked state”). The first locked state is a state in which the device screen is locked and requires authentication input from a user to unlock the display/screen and provide access to the applications installed on the device that are not accessible from the locked screen. In one embodiment, the hardware components include the input devices and the one or more applications stored in the memory are configured to access and received inputs from the at least one input device while the electronic device is in a first locked state. Other hardware components are also similarly accessible while the device is in the first locked state, based on permissions afforded to installed applications and the operating system. The electronic device also includes at least one processor communicatively coupled to the at least one hardware component and the memory. The at least one processor executes the operating system, firmware, and application software of the electronic device and is configured to cause the electronic device to: in response to detecting a transitioning of the electronic device to enter into a second locked state, de-activate a hardware channel associated with each of the at least one hardware component, the deactivation of the hardware channel preventing access by the one or more applications to access the at least one hardware component (e.g., receive inputs from the at least one input device), while the electronic device is in the second locked state.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

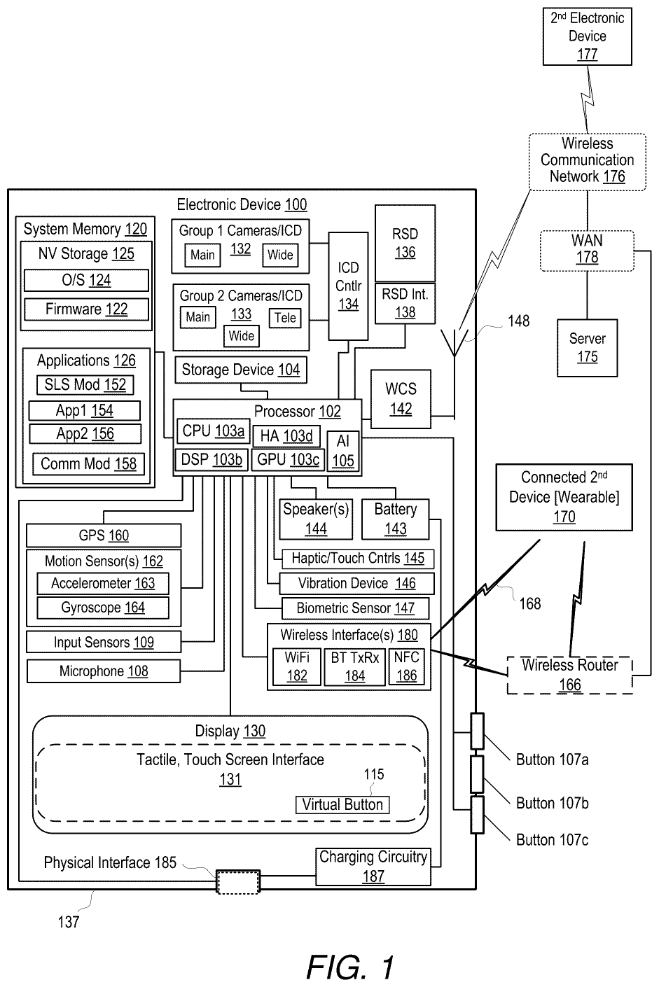

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific hardware, firmware, and software components that collectively enable the electronic device to be configured in a second (screen) lock state to enhance security of the electronic device and device user from eavesdropping on the device context and/or on the device user via a background application or service, in accordance with one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

FIG. 1 depicts an example component makeup of an electronic device with specific components that enable the electronic device to implement a secure lock feature that prevents background applications from accessing hardware devices while the electronic device is in the screen locked state, according to one or more embodiments. Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133. In one or more embodiments, one or more of cameras 132, 133 can be used to authenticate a user via facial recognition in order for the user to gain access to the electronic device from a locked screen.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102 (or controller 102). Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). As shown, system memory 120 specifically includes NV storage 125 within which is stored program code and data associated with firmware 122 and operating system 124. As described further herein, one or both of firmware 122 and operating system 124 may be modified to provide the functions and features described herein. System memory 120 also stores program code and data associated with one or more applications 126. During device operation, processor 102 processes program code of the various applications, modules, OS, and firmware, that are stored in system memory 120.

In accordance with one or more embodiments, applications 126 can include, without limitation, second/secure lock screen (SLS) module 152, and other applications, indicated as App1 154 and App2 156, and communication module 158. Other applications may also be present. Each module and/or application provides program instructions/code that are processed by processor 102 to cause/configure processor 102 and/or other components of electronic device 100 to perform specific operations, as described herein. As one aspect of the disclosure, one or more of applications 154 and 156 may be provided with permission to access hardware devices in the background, while electronic device is in a screen lock state (first lock state). As an example, an AI application that is designed to wake up the device by listening to voice audio while the device is asleep and/or in a screen locked state will remain in a listening mode by accessing the device microphone even while the screen is locked.

Descriptive names assigned to the above modules add no functionality and are provided solely to identify the underlying features performed by processing the different modules. For example, SLS module 152 can include program instructions for implementing various features of the disclosed embodiments. In one or more embodiments, the SLS module 152 includes program instructions that when processed via processor 102 configures processor 102 to cause the electronic device 100 to enable a second (screen) lock state and associated functionality of configuring the device to enter and exit the second lock state. Additionally, the SLS module 152 may include program instructions that cause the electronic device to perform other features of the disclosed embodiments. SLS module 152 and/or the features associated with SLS module 152, as described herein, can in one embodiment be integrated as an add-on or update to O/S 124 and/or firmware 122 via an OEM programming or later update of the O/S 124 and/or firmware 122.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications, including SLS module 152, stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 with tactile, touch screen interface 131 can be utilized as an input device that allows a user to provide input to or to control electronic device 100 by touching features within the user interface presented on display 130. The touch screen interface 131 can include one or more virtual buttons or other selectable items, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. While shown as a single integrated display, it is appreciated that electronic device 100 can include multiple integrated displays include both front and back displays, for example.

Electronic device 100 further includes housing 137 (generally represented by the thick exterior rectangle) that contains/protects the components internal to electronic device 100. Electronic device 100 can further include microphone 108, other input sensors 109 (e.g., sensors enabling gesture detection by a user), and one or more physical input buttons, indicated as 107a, 107b, and 107c, extended from housing 137. Microphone 108 can also be referred to as an audio input device. In some embodiments, microphone 108 may be used for identifying a user via voiceprint, voice recognition, and/or other suitable techniques. Input buttons 107a-107c may provide controls for volume, power, and ICDs 132, 133. While three physical buttons are shown in FIG. 1, other embodiments may have more or fewer input buttons.

Additionally, electronic device 100 can include one or more output devices such as speakers 144. Electronic device 100 further includes haptic touch controls 145, vibration device 146, fingerprint sensor/biometric sensor 147, global positioning system (GPS) adapter/module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, an ICD can be utilized as a biometric sensor for facial recognition, and ICD can be in addition to and/or supplement biometric sensor 147 for user detection/identification.

GPS adapter/module 160 can provide time data and location data about the physical location of electronic device 100 using geospatial input received from GPS satellites. Motion sensor(s) 162 can include one or more accelerometers 163, gyroscope 164, and barometer 165. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y, and Z). Gyroscope 164 measures rotation or angular rotational velocity of electronic device 100.

In one or more embodiments, input signals from motion sensors 162 are analyzed along with other device data to determine a user context. Accordingly, by combining inputs from these motion sensors 162 with network context, the electronic device can determine the user's current activity, via a process referred to as “activity recognition”. With the user's context determined/identified, specific user actions or environmental situations, such as the user being “In Vehicle” (e.g., on a bus, train, car, etc.), can trigger the device being placed in the second lock stated, e.g., for private car scenarios. In one or more embodiments, the activation of the second lock state and associated features can be automated based on the user's current context matching a predefined user context (activity). Thus, one or more embodiments provides that the electronic device includes one or more sensors from among device sensors comprising a gyroscope, an accelerometer, and a barometer. The device also includes a communications subsystem comprising at least one interface for connecting the electronic device to one or more networks. The at least one processor is communicatively connected to each of the one or more sensors and the communications subsystem. The at least one processor is configured to cause the electronic device to: determine, in part based on a connectivity of the electronic device to an identified network and sensed inputs received from the one or more sensors, a device context; perform activity recognition by correlating the device context with activity of a device user; and automatically activate the second lock feature in response to the activity recognition indicating a user context that falls within a pre-determined set of user contexts that require removal of access by the one or more applications from the at least one input device.

Electronic device 100 also includes a physical interface 185. Physical interface 185 of electronic device 100 can serve as a data port and can also be used as a power supply port that is coupled to charging circuitry 187 and device battery 143 to enable recharging of device battery 143 and/or powering of electronic device 100.

Electronic device 100 further includes wireless communication subsystem (WCS) 142, which can represent one or more front end devices (not shown) that are each coupled to one or more antennas 148. In one or more embodiments, WCS 142 can include one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected second wireless devices 177, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices (e.g., second wireless communication device 177), which can be similarly connected to wireless communication network 176 or connected via a wide area network (WAN) 178, such as the Internet. In one or more embodiments, various functions that are being performed on electronic device 100 can be supported using or completed via/on server 175. In one or more embodiments, server 175 can store SLS modules 152 or downloadable versions of SLS module 152. Moreover, in one or more embodiments, based on the input signals from motion sensors, server 175 can perform motion data analysis to identify a user context and device context.

Electronic device 100 includes wireless interface(s) 180, which enables electronic device 100 to wirelessly communicate with wireless communication network 176 via communication signals 168 transmitted by short range communication device(s). Wireless interface(s) 180 can include transceivers and/or a short-range wireless communication adapters, including wireless fidelity (Wi-Fi) transceivers 182 for Wi-Fi connectivity, Bluetooth transceiver 184, and near field communication (NFC) transceiver 186, etc. In one or more embodiments, electronic device 100 can receive Internet or Wi-Fi based calls, text messages, multimedia messages, and other notifications via wireless interface(s) 168. In one or more embodiments, electronic device 100 can communicate wirelessly with external wireless devices, such as a WiFi router 166, via wireless interface(s) 180. In one or more embodiments, electronic device 100 can be communicatively connected with a wireless signal connection 168 to/with a connected second device 170, which can be user wearable device 170, via direct connection with one of the external wireless interfaces 180 (e.g., BT) or indirectly via a local network, such as provided by WiFi router 166. Connected second device 170 can be a wearable device having a Bluetooth adapter to enable Bluetooth connectivity with electronic device 100. In one or more embodiments, WCS 142 with antenna(s) 148 and wireless interface(s) 180 collectively provide and can be generally referred to as wireless communications subsystem of electronic device 100.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device. Accordingly, with ongoing reference to FIG. 1, one aspect of the disclosure provides an electronic device comprising: at least one input device; a memory having stored thereon one or more applications that are configured to access and received inputs from the at least one input device while the electronic device is in a first locked state; and at least one processor communicatively coupled to the at least one input device and the memory. The at least one processor is programmed to execute modified firmware of the electronic device, and the at least one processor is configured to cause the electronic device to: in response to detecting a transitioning of the electronic device to enter into a second locked state, de-activate a hardware channel associated with each of the at least one hardware components, the deactivation of the hardware channel preventing access by the one or more applications to access the at least one hardware component, while the electronic device is in the second locked state.

According to one or more embodiments, the at least one processor is further configured to cause the electronic device to: transition into a secure authentication access mode that requires verification of an authentication input to trigger reactivation of the at least one hardware channel and restore access to the at least one hardware component, including to receive input from the at least one input device; monitor for receipt of an access authentication input to unlock the device; and in response to verification of the access authentication input: reactivate the at least one hardware channel to provide access to the at least one hardware component; and unlock the electronic device.

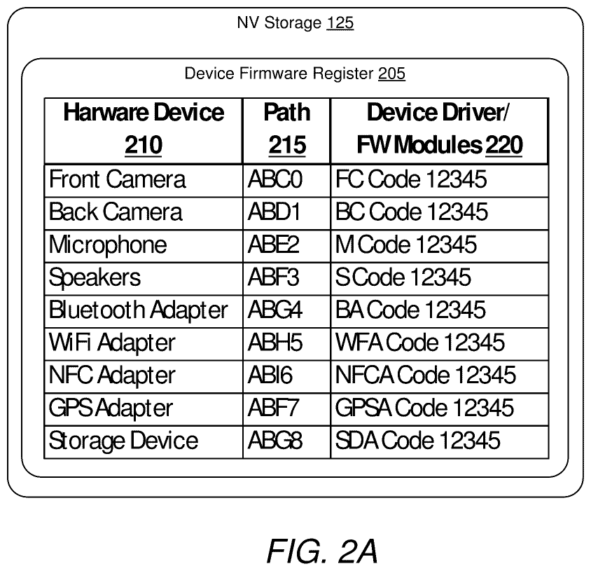

FIG. 2A is an example illustration of nonvolatile (NV) storage 125 having a device firmware register 205. Firmware register 205 includes a listing 210 of each hardware device component with its associated firmware module (or device driver) 220 and corresponding path 215, one or both of which can be modified to prevent user level or OS level access to the hardware in order to support a second locked state of the electronic device, according to one or more embodiments. Included in the listing 210 within firmware register 205 are a plurality of OS/Firmware controllable hardware devices, including front camera(s), back camera(s), microphone, speakers, BT adapter, WiFi Adapter, NFC adapter, GPS adapter, and storage device. In one or more embodiments, the at least one hardware component comprises at least one of a microphone, a speaker, a camera, a biometric scanner, a storage device, and one or more of the wireless connection adapter/component. Thus, while the embodiments present examples that are typically associated with an input device (e.g., microphone), the described aspects of the disclosure are generally applicable to a plurality of different types of hardware components, including both input devices as well as non-input devices, where each hardware components has a corresponding hardware channel that is accessible to installed applications and the OS and that can be deactivated by the processor, based on specific user and device settings.

Each hardware device has an associated device driver or firmware module 220, which is accessed via a path (i.e., a memory access) 215 by operating system 124 (FIG. 1). For the hardware device to operate, the O/S 124 has to be able to access the associated device driver/FW module 220 via the provided path 215. According to one or more embodiments, a change or modification to one or both of the path 215 or the device driver 220 can cause the hardware device to become non-functional (i.e., appear to not be present for access by the user application or O/S).

Accordingly, in one or more embodiments, the electronic device includes at least one firmware component associated with operation of a corresponding hardware channel, where to deactivate the at least one hardware channel the at least one processor is configured to de-activate a corresponding firmware component for each of the at least one hardware channel.

FIG. 2B provides a rudimentary example of one modification that can be made to the device firmware register 205 when the electronic device 100 is made to enter the second lock state. As shown, to enter into the second lock state, each of the paths 215B is modified to prevent the O/S 124 from being able to access the device drivers/firmware modules 220 of the hardware devices. The modified paths 215B effectively blocks or removes access to the hardware channels that are required for the corresponding hardware devices to be functional. In the illustrated embodiment, a final bit value is removed from each path 215B and stored within a restore codes block 225 that is stored in another location of NV storage 125. Thus, the modification does not affect the driver software, but instead makes the driver appear to be missing or not accessible to the OS and background applications that may desired to use the particular hardware device while the electronic device is in a locked screen state. It is appreciated that in other embodiments, other means of blocking access to the hardware channels can be employed, including changing certain blocks of initial code within the device driver 220 itself, such that the device driver 220 and, by extension, the hardware device is non-operational. Additionally, with the presented embodiment, restoring the path when the device is moved out of the second locked state can be simply performed by concatenating the restore code blocks to the path or re-adding the removed bits to the modified path 215B to reconstitute the original path 215A. Other processes are contemplated outside of the presented examples, without limitation.

FIG. 2C presents another example of partial hardware channel restriction that can be made to the device firmware register 205 when the electronic device 100 is made to enter the second lock state or is temporarily exiting the second lock state to support one of a plurality of pre-identified triggering conditions. As shown, the paths 215C for front camera, microphone, speaker, and BT adapter have been restored (or were not initially restricted), such that these hardware devices are fully functional and accessible to background applications and the OS while the device is in the second or first locked state. A corresponding block of restore codes are provided for the remaining of the hardware devices whose hardware channels are blocked.

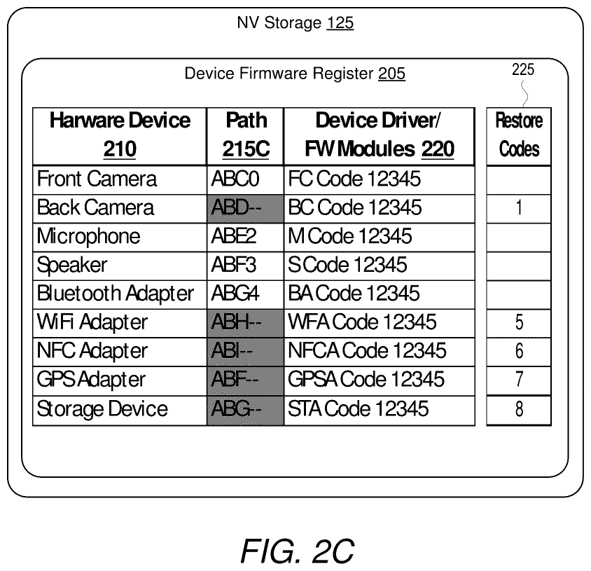

In one or more embodiments, the at least one processor is further configured to cause the electronic device to monitor for receipt of an exception trigger that is pre-established to temporarily override the de-activation of the hardware channel. The exception trigger can be one from a group that includes: receipt of an incoming audio call, where the at least one hardware component includes a microphone that is temporarily re-activated to enable answering the incoming call and communicating audio input with the audio call; receipt of an emergency call; and receipt of an audio-video call, where the at least one hardware component includes a microphone and a camera that are temporarily re-activated to enable answering and communicating audio and video input with the audio-video call. Other exception triggers can be accounted for and may be user-specified exceptions as presented in FIG. 4 (430). In one or more embodiments, in response to receipt of the exception trigger, the at least one processor configured to cause the electronic device to: transition the electronic device to an intermediate locked state that enables device operations associated with the exception trigger; re-activate at least one hardware channel that is required for completion of one or more device functions corresponding to the received exception trigger; and enable completion of the one or more device functions associated with the exception trigger, using the activated hardware devices. The intermediate lock state allows the operating function or application (e.g., a video calling application) to access those hardware channels of the hardware devices that are required to complete the particular operation (e.g., the camera hardware channel and the microphone and speaker hardware channels). Unlike the first lock state, the intermediate lock state does not provide access to other hardware channels that are not required to complete the particular function. Thus, in the provided example, access to the SD card or NFC channels may continue to be blocked while the video call is enabled on the device following receipt of an incoming video call request while the device is in the second locked state.

Further, in one or more embodiments, the at least one processor is further configured to cause the electronic device to: monitor for completion of the one or more device functions; and reconfigure the electronic device into the second locked state by de-activating the at least one hardware channel required for completion of the one or more device functions.

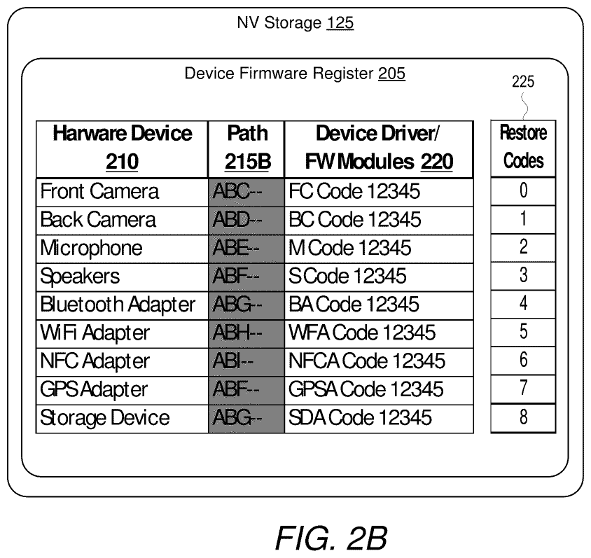

FIG. 3 depicts an example settings user interface for configuring the electronic device to operate in a second lock state that prevents access to hardware devices by background applications, according to one or more embodiments. Settings application includes lock screen & Always On Display (AOD) UI 310, which is presented on display 130 of electronic device 100 (FIG. 1). Within LS & AOD UI 310 is presented second lock state entry 315 which can be toggled on (e.g., from a default off position) by toggling option on/off slider 320 on (i.e., pulling option slider button to the rightmost side of option on/off slider 320). LS & AOD UI 310 is also shown with an AOD entry 325 and similar option on/off slider 330.

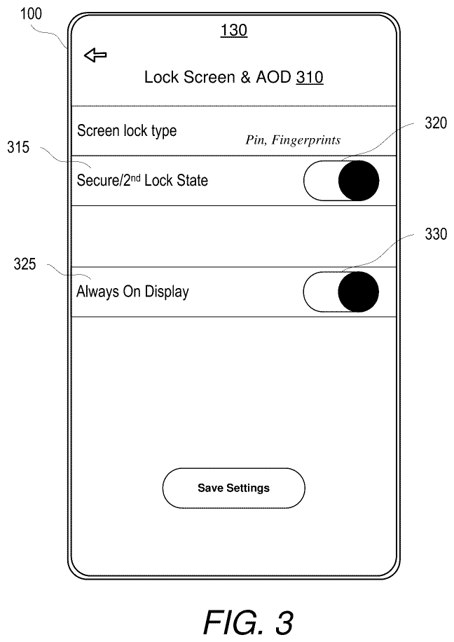

FIGS. 4 and 5 depict different embodiments of second lock screen setup/settings UI 410 and 510 presented on display 130 of electronic device 100. In FIG. 4, Secure/Second Lock Screen Settings (SLSS) UI 410 includes entry for screen unlock type, indicated as security pin entry and fingerprints. SLSS UI 410 also include entry for selecting from among full system device lock and partial system device lock, each having a corresponding on/off slider 415 and 420. Partial system device lock provides an option for the user to select which hardware devices are actually locked from access by the background applications during the second lock state. At the bottom of SLSS UI 410, once partial system device lock is toggled on (420), SLSS UI 410 presents two active option buttons 425 and 430 for respectively selecting which hardware channels to block during a screen lock and which functions and/or features are to be added to the exceptions list for services or applications that can override the hardware locked state while the device is in the second lock state.

FIG. 5 shows secure lock hardware setting UI 510 by which individual listing of select hardware devices are presented for granular selection of specific devices to lock or leave unlock while the device is in the second lock screen state. UI 510 can be rendered and presented in response to selection of option button 425 in SLSS UI 410. As shown, the entries for microphone and camera are toggle on, while the entry for SD card is off, as indicated by the respective on/off option sliders 515, 520, 525. Once the user has selected which devices to disable access to by toggling the corresponding option slider to the off position, user is able to select the save settings button or the exit button to return to a previous screen or exit the setting UI altogether.

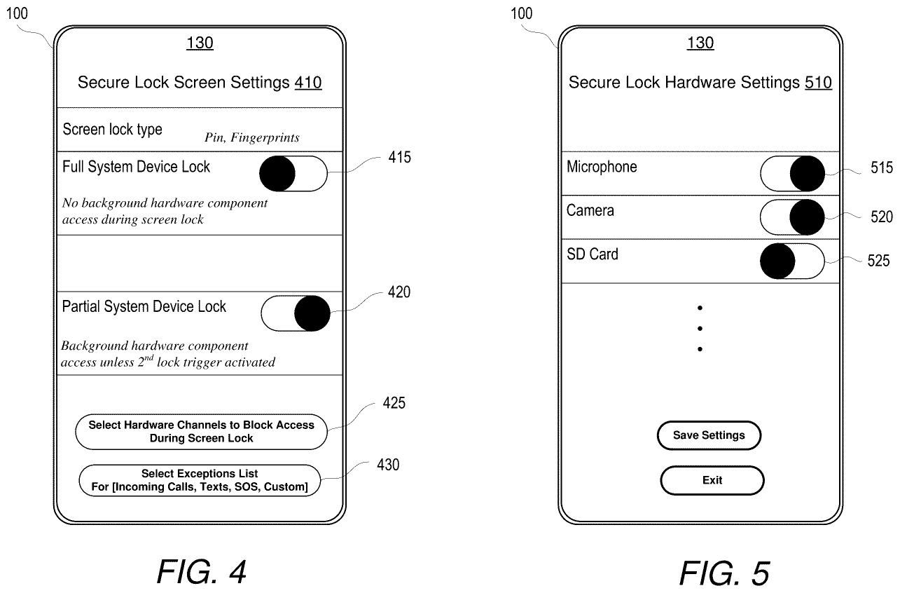

FIG. 6 depicts electronic device 100 with a modified first lock screen 605 with selectable options (610, 615) for transitioning the device 100 to the second locked state, according to one or more embodiments. As shown by the label, electronic device 100 is in a first lock state and presents a corresponding first lock screen 605. Electronic device 100 is configured to operate in both the first lock state and the second lock state, triggered by a user selection. First lock screen 605 does not prevent background apps from accessing the hardware channels and as such is configured to made the user aware of the option to securely lock the device by presenting at least one of selectable lock icon 610 or selectable lock message button 615. It is appreciated that only one of the two options may be presented in some embodiments, and that the specific presentation may be a user selection when configuring the lock screen settings.

Accordingly, in one or more embodiments, the at least one processor is configured to: render a lock screen for the first locked state, the lock screen comprising a selectable option for transitioning the electronic device from the first locked state to the second locked state; monitor for receipt of a user selection of the selectable option; and in response to detecting user selection of the selectable option, configuring the electronic device into the second locked state.

Further, in one or more embodiments, the at least one processor is further configured to: render a user interface with a selectable option for activating the second lock state of the electronic device; and in response to receipt of a selection of the selectable option, automatically update a firmware of the electronic device to configure the electronic device to transition to the second locked state at each instance in which a locked state of the electronic device is triggered.

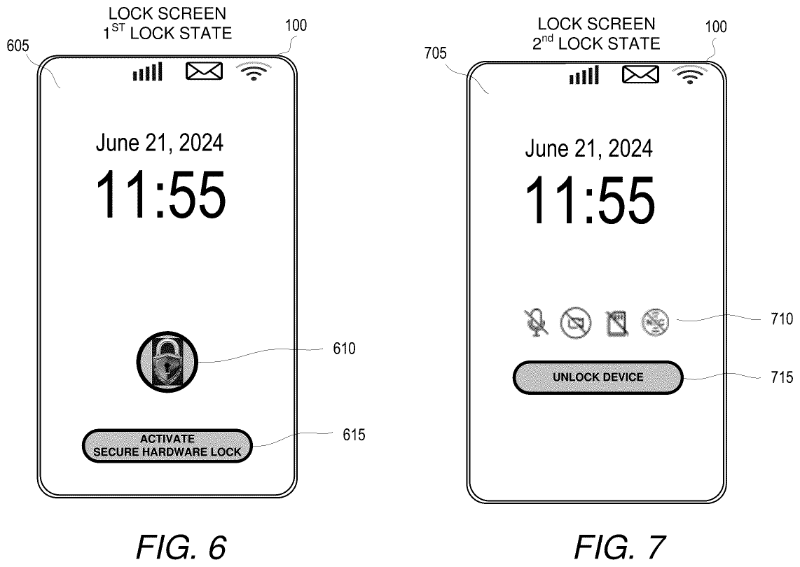

FIG. 7 depicts the electronic device of FIG. 6 after selection of one or the selectable options (610, 615) for device to transition to the second locked state. Electronic device 100 presents second lock screen 705 with graphical indications 710 that access to the indicated hardware devices are locked, according to one or more embodiments. Second lock screen 705 can also include or present an unlock device button 715 that allows for a manual override of the lock screen to allow a user to enter their login credentials and restore the electronic device 100 to its original settings that allowed hardware channel access to certain background applications. It is appreciated that other embodiments can provide that the second lock screen be presented without the indications 710 or unlock device button 715.

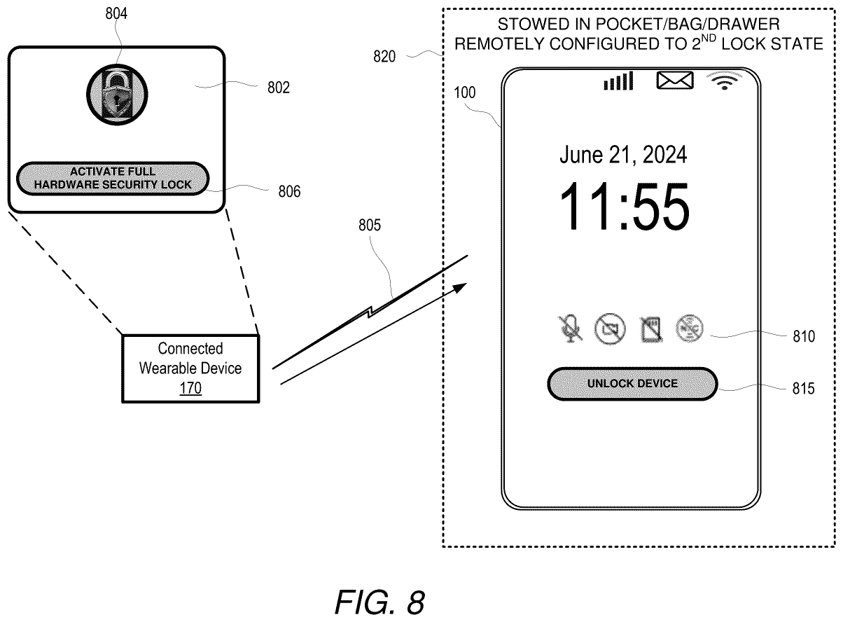

According to one or more embodiments, a connected second device, such as a smart watch, has the ability to activate a feature on the electronic device. As an example, if a user wishes to have a private conversation, the user's smart watch can generate a signal that triggers the electronic device to enter sandbox mode, disabling the hardware channel. By using this approach, the user is able to avoid the inconvenience of having to first locate the device that may be not quickly accessible, such as being stowed in the user's pocket/purse/bag before the feature can be turned on. FIG. 8 illustrates an example environment in which electronic device 100 can be placed in the second locked state by a remote trigger (810) provided by a connected second device (170), according to one or more embodiments. As shown by the example, electronic device 100 is stowed in a pocket or bag or drawer (generally represented by dashed lines 820) away from the user's view or immediate reach. Electronic device is initially in the first locked state while connected via BT or other wireless connection (810) to connected second device 170. Connected second device 170 is also a wearable device, such as a smart watch that has a display 802 and a near field communication module/device, such as a BT transceiver (not shown). When electronic device 100 enters the first lock state, at least one notification (804, 806) is rendered and presented on display 802 of connected second device 170. The notification can be a selectable icon 804 or a selectable message button 806. Selection by a user of either selectable icon 804 or selectable message button 806 causes the generation and transmission of a notification trigger (see arrow) via wireless transmission 805, which is received by the processor of electronic device and configures the processor to transition electronic device from one of the open state or the first locked state into the second lock state. Electronic device 100 is illustrated after being triggered to transition to second lock state in which UI presents lock indications 810 and unlock device selection button 815.

Thus, according to one or more embodiments, the electronic device further includes a communications subsystem comprising at least one interface for connecting the electronic device to one or more second devices. In one embodiment, the one or more second devices includes a wearable or on-user device and the at least one processor is communicatively connected to the communications subsystem and is configured to cause the electronic device to: receive a device lock input signal from a connected one of the wearable or on-user device, the input signal correlated to a request for entry by the electronic device into the second lock state; and automatically transition the electronic device into the second lock state in response to receiving the device lock input signal.

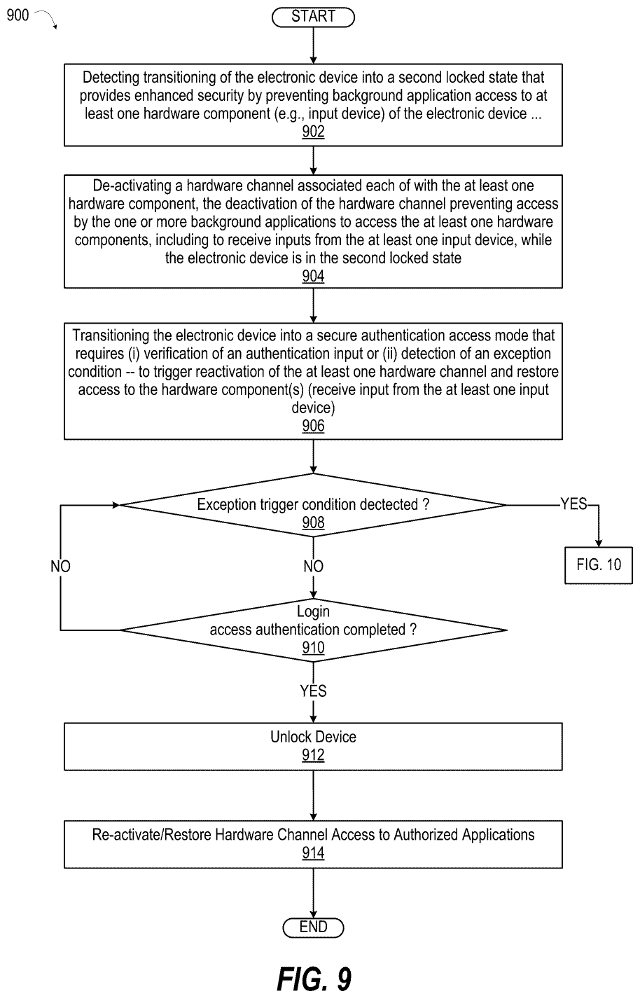

Referring now to the flowcharts presented by FIGS. 9, 10, and 11, the descriptions of the methods in FIGS. 9, 10, and 11 are provided with general reference to the specific components and features illustrated within the preceding FIGS. 1-8. Specific components referenced in the methods of FIGS. 9, 10, and 11 may be identical or similar to components of the same name used in describing preceding FIGS. 1-8. In one or more embodiments, processor 102 (FIG. 1) configures electronic device 100 (FIG. 1) to provide the described functionality of the methods of FIGS. 9, 10, and 11 by executing program code for one or more modules or applications provided within system memory 120 of electronic device 100, including SLS module 152 (FIG. 1).

FIG. 9 depicts a flowchart of a computer-implemented method 900 for enabling the electronic device to be placed into and operate in a second lock state, according to one or more embodiments. Following the start block, method 900 includes detecting by a processor 102 of an electronic device 100 a transitioning of the electronic device 100 into a second locked state that provides enhanced security by preventing background application access to at least one hardware component of the electronic device that has a corresponding hardware channel used by the background application to access the hardware component (block 902). Method 900 includes, in response to detecting transitioning of the electronic device into the second locked state, de-activating a hardware channel associated each of with the at least one hardware component, the deactivation of the hardware channel preventing access by the one or more background applications to access the at least one hardware component including preventing receipt of inputs from the at least one input device while the electronic device is in the second locked state (block 904). In one or more embodiment, deactivating the at least one hardware channel comprises de-activating a corresponding firmware component for each of the at least one hardware channel. Method 900 includes transitioning the electronic device into a secure authentication access mode that requires either verification of an authentication input or detection of an exception condition to trigger reactivation of the at least one hardware channel and restore access to at least one hardware component and receive input from the at least one input device (block 906). Accordingly, in addition to the restoration of access to input devices, method 900 provides for restoring access to utilize one or more of the other hardware components/devices that are not input devices (e.g., SD card). Method 900 then includes monitoring for and identifying, at decision block 908, whether an exception trigger condition is detected. In response to detection of the exception trigger, method 900 transitions to method 1000, which is described hereafter. In the absence of an exception trigger, method 900 transitions to decision block 910 at which method 900 includes detecting whether a login access authentication process has been completed. Specifically, method 900 includes monitoring for receipt of an access authentication input to unlock the device. In response to verification of the access authentication input, method includes unlocking the electronic device (block 912) and reactivating the at least one hardware channel to provide access to the at least one hardware component (block 914). Method 900 then ends.

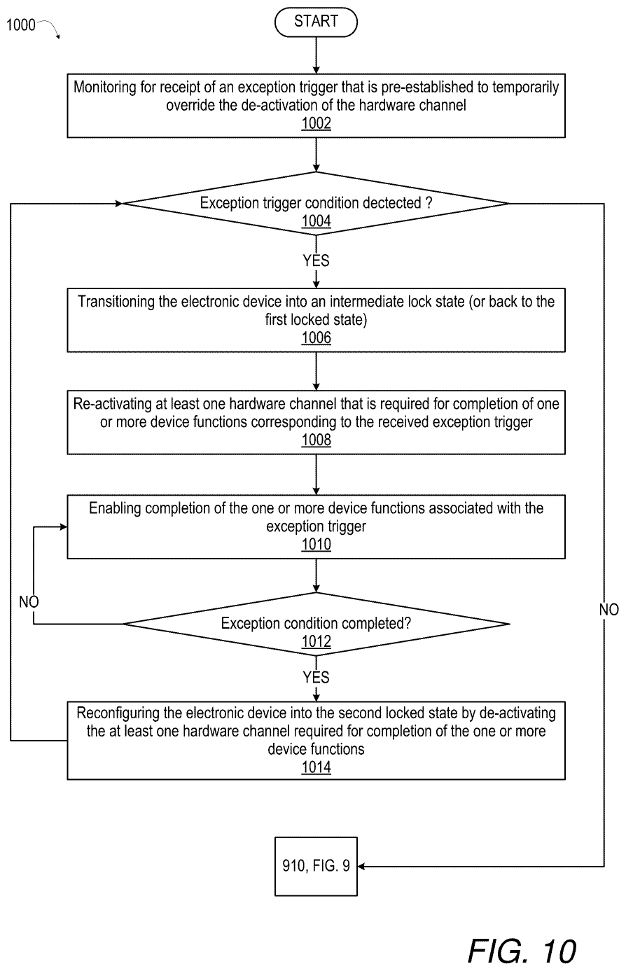

FIG. 10 depicts a flowchart of a second computer-implemented method for responding to an exception condition that is received/detected while the electronic device is in the second locked state, according to one or more embodiments. Following the start block, method 1000 includes monitoring for receipt of an exception trigger that is pre-established to temporarily override the de-activation of the hardware channel (block 1002). Method includes determining at block 1004 whether an exception trigger has been detected/received. The exception trigger can include, but is not limited to including one from a group that includes: receipt of an incoming audio call, where the at least one hardware component comprises a microphone that is temporarily re-activated to enable answering the incoming call and communicating audio input with the audio call; receipt of an emergency call; and receipt of an audio-video call, where the at least one hardware component comprises a microphone and a camera that are temporarily re-activated to enable answering and communicating audio and video input with the audio-video call. Method 1000 includes in response to receipt of the exception trigger: transitioning the electronic device to an (screen) locked state that enables device operations associated with the exception trigger (block 1006); and re-activating at least one hardware channel that is required for completion of one or more device functions corresponding to the received exception trigger (block 1008). As previously introduced, the intermediate screen lock state allows the operating function or application (e.g., a video calling application) to access those hardware channels of the hardware devices that are required to complete the particular operation (e.g., the camera hardware channel and the microphone and speaker hardware channels). Unlike the first lock state, the intermediate lock state does not provide access to other hardware channels that are not required to complete the particular function.

Method 1000 then includes enabling completion of the one or more device functions associated with the exception trigger, using the re-activated hardware channels to access the corresponding hardware devices (block 1010). Method 1000 includes monitoring for completion of the device functions associated with the exception trigger and determining at block 1012 whether the operations associated with the exception condition has/have completed. Method 1000 includes reconfiguring the electronic device into the second locked state by de-activating the at least one hardware channel required for completion of the one or more device functions (block 1014). When there is no exception condition detected, method ends and/or returns to block 910 of FIG. 9.

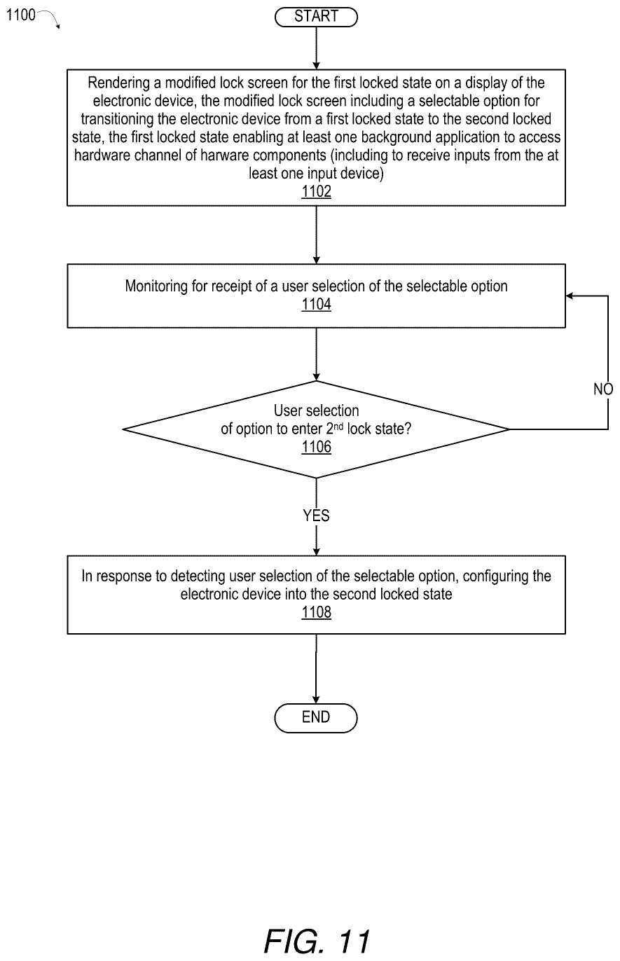

FIG. 11 illustrates a flowchart of a third computer-implemented method 1100 for activating the second lock state of the electronic device based on user selection, according to one or more embodiments. Method 1100 includes rendering a modified lock screen for the first locked state on a display of the electronic device, the modified lock screen including a selectable option for transitioning the electronic device from a first locked state to the second locked state, the first locked state enabling at least one background application to access the at least one hardware component, including to receive inputs from the at least one input device (block 1102). In one or more alternate embodiments, method 1100 can also include rendering a user interface with a selectable option for activating the second lock state of the electronic device. Method 1100 includes monitoring for receipt of a user selection of the selectable option (block 1104) and determining at block 1106 whether the user selection is received. Method 1100 includes, in response to detecting user selection of the selectable option, configuring the electronic device into the second locked state (block 1108). In one or more embodiment, method 1100 can also include in response to receipt of a selection of the selectable option, automatically updating a firmware of the electronic device to configure the electronic device to transition to the second locked state at each instance in which a locked state of the electronic device is triggered. Method 1100 then ends.

As can be appreciated, the disclosed embodiments provide techniques for preventing background applications from accessing hardware resources of the electronic device while the device is in a locked stated in order to protect against potential unintended situations, such as eavesdropping on a device user, by the background application. With the embodiments provided, the user is able to better control what services are enabled while the device is in the locked state, without having to worry about remembering which background services may or may not have access to one or more of the device hardware channels. Thus, the disclosure provides significant benefits to ensuring user privacy and user control of device activity by eliminating or suspending the autonomous controls that are otherwise enabled for background applications.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

According to one or more aspects, a computer program product is provided that includes: a non-transitory computer readable medium; and program instructions on the computer readable medium that is executable by a processor of an electronic device to configure the electronic device to perform the functions of the above-described method processes.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one hardware component each having a corresponding hardware channel for access to a respective one of the at least one hardware component by one or more applications and an operating system, the at least one hardware component comprising at least one input device;
a memory having stored thereon the one or more applications and the operating system that are configured to access the at least one hardware component, including while the electronic device is in a first locked state; and
at least one processor communicatively coupled to the at least one hardware component and the memory, the at least one processor executing firmware of the electronic device and is configured to cause the electronic device to:
in response to detecting a transitioning of the electronic device to enter into a second locked state, de-activate a hardware channel associated with each of the at least one hardware component, a deactivation of the hardware channel preventing access by the one or more applications to access the at least one hardware component while the electronic device is in the second locked state.

2. The electronic device of claim 1, wherein the at least one processor is further configured to cause the electronic device to:
transition into a secure authentication access mode that requires verification of an authentication input to trigger reactivation of the hardware channel and restore access to the respective at least one hardware component, including to receive input from the at least one input device;
monitor for receipt of an access authentication input to unlock the electronic device; and
in response to verification of the access authentication input: reactivate the hardware channel to provide access to the at least one hardware component and receive input from the at least one input device; and unlock the electronic device.

3. The electronic device of claim 1, wherein the at least one hardware component comprises at least one of a microphone, a speaker, a camera, a biometric scanner, a storage device, and each wireless connection adapter/component.

4. The electronic device of claim 1, further comprising at least one firmware component associated with operation of a corresponding hardware channel, wherein to deactivate the hardware channel the at least one processor is configured to de-activate a corresponding firmware component for each hardware channel.

5. The electronic device of claim 1, wherein the at least one processor is further configured to cause the electronic device to:
monitor for receipt of an exception trigger that is pre-established to temporarily override the de-activation of the hardware channel; and
in response to receipt of the exception trigger:
transition the electronic device to an intermediate locked state that enables device operations associated with the exception trigger;
re-activate at least one hardware channel that is required for completion of one or more device functions corresponding to the exception trigger; and
enable completion of the one or more device functions associated with the exception trigger.

6. The electronic device of claim 5, wherein the at least one processor is further configured to cause the electronic device to:
monitor for completion of the one or more device functions; and
reconfigure the electronic device into the second locked state by de-activating the at least one hardware channel required for completion of the one or more device functions.

7. The electronic device of claim 5, wherein the exception trigger comprises one from a group comprising:
receipt of an incoming audio call, wherein the at least one hardware component comprises a microphone that is temporarily re-activated to enable answering the incoming audio call and communicating audio input with the audio call;
receipt of an emergency call; and
receipt of an audio-video call, wherein the at least one hardware component comprises a microphone and a camera that are temporarily re-activated to enable answering and communicating audio and video input with the audio-video call.

8. The electronic device of claim 1, further comprising:
a display device communicatively coupled to the at least one processor; and
wherein the at least one processor is configured to:
render a lock screen for the first locked state and present the lock screen on the display device, the lock screen comprising a selectable option for transitioning the electronic device from the first locked state to the second locked state;
monitor for receipt of a user selection of the selectable option; and
in response to detecting user selection of the selectable option, configuring the electronic device into the second locked state.

9. The electronic device of claim 1, wherein the at least one processor is further configured to:
render a user interface with a selectable option for activating the second lock state of the electronic device; and
in response to receipt of a selection of the selectable option, automatically update a firmware of the electronic device to configure the electronic device to transition to the second locked state at each instance in which a locked state of the electronic device is triggered.

10. The electronic device of claim 1, further comprising:
one or more sensors from among device sensors comprising a gyroscope, an accelerometer, and a barometer; and
a communications subsystem comprising at least one interface for connecting the electronic device to one or more networks;
wherein the at least one processor is communicatively connected to each of the one or more sensors and the communications subsystem and is configured to cause the electronic device to:
determine, in part based on a connectivity of the electronic device to an identified network and sensed inputs received from the one or more sensors, a device context;
perform activity recognition by correlating the device context with activity of a device user; and
automatically activate the second lock state in response to the activity recognition indicating a user context that falls within a pre-determined set of user contexts that require removal of access by the one or more applications from the at least one hardware component.

11. The electronic device of claim 1, further comprising:
a communications subsystem comprising at least one interface for connecting the electronic device to one or more second devices, the one or more second devices comprising a wearable or on-user device;
wherein the at least one processor is communicatively connected to the communications subsystem and is configured to cause the electronic device to:
receive a lock device input signal from a connected one of the wearable or on-user device, the lock device input signal correlated to a request for entry by the electronic device into the second lock state; and
automatically transition the electronic device into the second lock state in response to receiving the lock device input signal.

12. A method comprising:
detecting, by a processor of an electronic device, a transitioning of the electronic device into a second locked state that provides enhanced security by preventing background application access to at least one hardware component of the electronic device that has a corresponding hardware channel used by a background application to access the at least one hardware component; and
in response to detecting transitioning of the electronic device into the second locked state, de-activating a hardware channel associated each of with the at least one hardware component, the de-activating of the hardware channel preventing one or more background applications from accessing the at least one hardware component, including preventing receipt of inputs from at least one input device while the electronic device is in the second locked state.

13. The method of claim 12, further comprising:
transitioning the electronic device into a secure authentication access mode that requires verification of an authentication input to trigger reactivation of at least one hardware channel and restore access to at least one hardware component and receive input from the at least one input device;
monitoring for receipt of an access authentication input to unlock the device; and
in response to verification of the access authentication input: reactivating the at least one hardware channel to provide access to the at least one hardware component; and unlocking the electronic device.

14. The method of claim 12, wherein:
the at least one hardware component comprises at least one of a microphone, a speaker, a camera, a biometric scanner, a storage device, and each wireless connection adapter/component of the electronic device; and
each of the at least one hardware component comprises at least one firmware module associated with operation of a corresponding hardware channel, and deactivating the at least one hardware channel comprises de-activating a corresponding firmware module for each of the at least one hardware channel.

15. The method of claim 12, further comprising:
monitoring for receipt of an exception trigger that is pre-established to temporarily override the de-activation of the hardware channel; and
in response to receipt of the exception trigger:
transitioning the electronic device to an intermediate locked state that enables device operations associated with the exception trigger;
re-activating at least one hardware channel that is required for completion of one or more device functions corresponding to the exception trigger;
enabling completion of the one or more device functions associated with the exception trigger;
monitoring for completion of the one or more device functions; and
reconfiguring the electronic device into the second locked state by de-activating the at least one hardware channel required for completion of the one or more device functions.

16. The method of claim 15, wherein the exception trigger comprises one from a group comprising:
receipt of an incoming audio call, wherein the at least one hardware component comprises a microphone that is temporarily re-activated to enable answering the incoming call and communicating audio input with the audio call;
receipt of an emergency call; and
receipt of an audio-video call, wherein the at least one hardware component comprises a microphone and a camera that are temporarily re-activated to enable answering and communicating audio and video input with the audio-video call.

17. The method of claim 12, further comprising:
rendering a modified lock screen for a first locked state on a display of the electronic device, the modified lock screen comprising a selectable option for transitioning the electronic device from a first locked state to the second locked state, the first locked state enabling at least one background application to access the hardware channel for the at least one hardware component, including to receive inputs from the at least one input device;
monitoring for receipt of a user selection of the selectable option; and
in response to detecting user selection of the selectable option, configuring the electronic device into the second locked state.

18. The method of claim 12, further comprising:
rendering a user interface with a selectable option for activating the second locked state of the electronic device; and
in response to receipt of a selection of the selectable option, automatically updating a firmware of the electronic device to configure the electronic device to transition to the second locked state at each instance in which a locked state of the electronic device is triggered.

19. A computer program product comprising:
a non-transitory computer readable medium; and
program instructions on the computer readable medium that is executable by a processor of an electronic device to configure the electronic device to perform functions of:
detecting a transitioning of the electronic device into a second locked state that provides enhanced security by preventing background application access to at least one hardware component that has a hardware channel that is otherwise available for access by the background application; and
in response to detecting transitioning of the electronic device into the second locked state, de-activate a hardware channel associated with each of the at least one hardware component, the deactivation of the hardware channel preventing access by one or more background applications to access the at least one hardware component, including preventing receipt of inputs from at least one input device while the electronic device is in the second locked state.

20. The computer program product of claim 19, further comprising program instructions executable to configure the electronic device to complete the functions of:
transitioning the electronic device into a secure authentication access mode that requires verification of an authentication input to trigger reactivation of at least one hardware channel and restore access to the corresponding at least one hardware component;
monitoring for receipt of at least one of an access authentication input to unlock the device and an exception trigger that is pre-established to temporarily override the de-activation of the hardware channel;
in response to verification of the access authentication input: reactivating the at least one hardware channel to provide access to the at least one hardware component; and unlocking the electronic device; and
in response to receipt of the exception trigger: transitioning the electronic device to an intermediate locked state that enables device operations associated with the exception trigger; re-activating at least one hardware channel that is required for completion of one or more device functions corresponding to the exception trigger; enabling completion of the one or more device functions associated with the exception trigger; monitoring for completion of the one or more device functions; and reconfiguring the electronic device into the second locked state by de-activating the at least one hardware channel required for completion of the one or more device functions.
